(19) United States
(12) Patent Application Publication
(10) Pub. No.: US 2025/0159096 A1
(43) Pub. Date: May 15, 2025

(54) IMAGE FORMATION APPARATUS, IMAGE FORMATION METHOD, AND STORAGE MEDIUM

(71) Applicant: CANON KABUSHIKI KAISHA, Tokyo (JP)

(72) Inventor: SATOKI WATARIUCHI, Tokyo (JP)

(21) Appl. No.: 18/933,374

(22) Filed: Oct. 31, 2024

(30) Foreign Application Priority Data
Nov. 14, 2023 (JP) 2023-193499

(51) Int. Cl. H04N 1/387

(52) U.S. Cl. CPC H04N 1/3876; H04N 1/3872; H04N 1/3877; H04N 2201/0416

(57) ABSTRACT

The usability in a case where a combined image, which is obtained by integrating two scanned images of a specific original, is generated is improved. An image formation apparatus includes: an obtainment unit configured to obtain two cropped images by performing cropping processing on two scanned images corresponding to two original surfaces that are obtained by scanning a specific original; and a generation unit configured to generate a combined image, which is obtained by integrating the two cropped images obtained by the obtainment unit.

### BACKGROUND OF THE INVENTION

### Field of the Invention

The present disclosure relates to an image formation apparatus, an image formation method, and storage medium.

### Description of the Related Art

An image formation apparatus has an ID card copying function to generate a combined image, which is obtained by integrating scanned images of two original surfaces obtained by scanning a front surface and a back surface of a specific original such as an ID card including a license, for example. Regarding this ID card copying function, Japanese Patent Laid-Open No. 2009-100102 (PTL 1) discloses a technique in which predetermined image processing according to a type and an original surface of a designated specific original is performed on a scanned image of the original surface obtained by scanning the original surface of the specific original.

However, with the technique disclosed in PTL 1, in a case where the above-described ID card copying function is performed, if a position of the specific original placed on a platen glass for the scanning is different from a position set in advance, there is a possibility that a desired output result cannot be obtained. For example, it is assumed in the above-described ID card copying function that a region corresponding to a license size, in which the origin is at the upper left of the platen glass, is set as a reading region of the specific original. In a case of such setting, if the position of the license placed on the platen glass is outside the above-described reading region, it has been only possible to form an image in which a scanned image including no image of the license is laid out on one surface of a single sheet. Additionally, in a case where the license placed on the platen glass is in a position traversing the inside and the outside of the above-described reading region, it has been only possible to form an image in which a scanned image including an image of a part of the entire one surface of the above-described license that is within the above-described reading region is laid out. Moreover, since it has been impossible to determine the quality of an output result without looking the output result, it has been necessary to redo the operations from the reading of the license in a case where the license cannot be read appropriately, and the user operation has been cumbersome.

### SUMMARY OF THE INVENTION

An image formation apparatus according to an aspect of the present disclosure includes: an obtainment unit configured to obtain two cropped images by performing cropping processing on two scanned images corresponding to two original surfaces that are obtained by scanning a specific original; and a generation unit configured to generate a combined image, which is obtained by integrating the two cropped images obtained by the obtainment unit.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration example of an image formation apparatus;

FIG. 2 is a block diagram illustrating a software configuration example of the image formation apparatus;

FIG. 3 is a flowchart describing processing of an ID card copying function;

FIG. 4A to FIG. 4G are each a diagram illustrating a UI screen example;

FIG. 5A to FIG. 5E are each a diagram describing processing of the ID card copying function;

FIG. 6 is a diagram illustrating a UI screen example; and

FIG. 7 is a flowchart describing processing of the ID card copying function.

### DESCRIPTION OF THE EMBODIMENTS

Embodiments of a technique of the present disclosure are described below with reference to the drawings. Note that, a constituent described in the following embodiments is an example and is not intended to limit the scope of the technique of the present disclosure. Note that, each step in a flowchart is described with “S” provided at the beginning.

### Embodiment 1

In the present embodiment, an aspect in which positions where two card images are to be laid out on a sheet are determined according to a set layout method, and printing data is generated is described.

### (Hardware Configuration of Image Formation Apparatus)

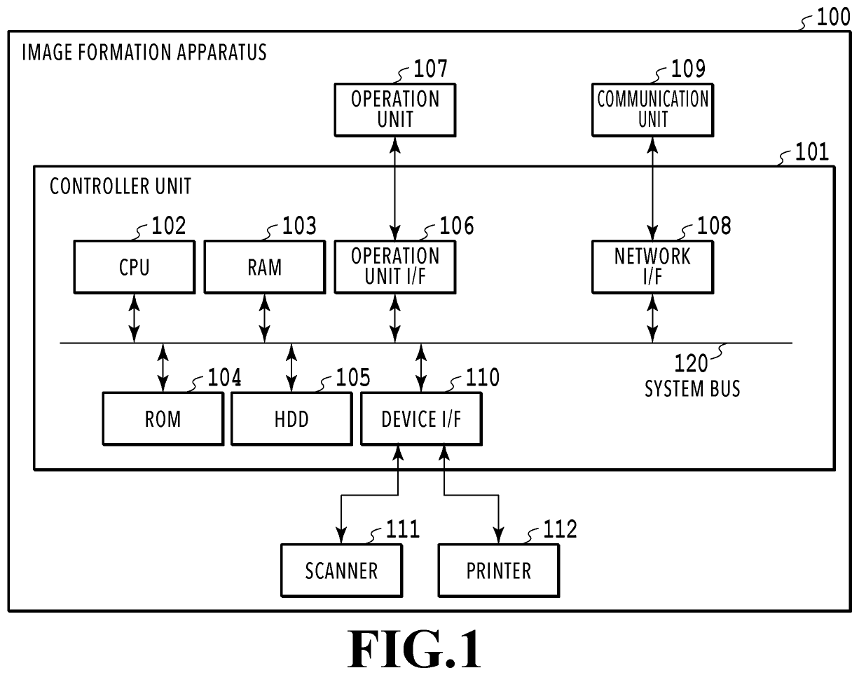

FIG. 1 is a block diagram illustrating a hardware configuration example of an image formation apparatus 100 according to the present embodiment. The image formation apparatus 100 includes a controller unit 101, an operation unit 107, a communication unit 109, a scanner 111, and a printer 112. The controller unit 101 controls the scanner 111, the printer 112, the operation unit 107, and the communication unit 109. In a case where a user uses a copying function, the controller unit 101 obtains, as image data of an original, a scanned image corresponding to an original surface that is obtained by reading the original placed on a platen glass by controlling the scanner 111. The controller unit 101 then controls the printer 112 and prints and outputs an image on a sheet based on the obtained image data.

Additionally, in a case where the user uses a scanning function, the controller unit 101 obtains the image data of the original by controlling the scanner 111, converts the image data into code data, and transmits the code data to an external device (not illustrated) via the communication unit 109. An instruction to execute processing in each of the above-mentioned functions is called a job, and the image formation apparatus 100 executes predetermined processing according to the job corresponding to each function.

The controller unit 101 includes a CPU 102, a RAM 103, a ROM 104, an HDD 105, an operation unit I/F 106, a network I/F 108, and a device I/F 110. These devices are connected with a system bus 120 so as to be able to transmit and receive data to and from each other.

The central processing unit (CPU) 102 controls overall the entirety of the image formation apparatus 100. The random access memory (RAM) 103 is a system working memory for an operation by the CPU 102 and is an image memory to temporarily store the image data. Additionally, the RAM 103 also stores a program and data such as an operating system, system software, and application software. Moreover, the RAM 103 stores data of the scanned image corresponding to the original surface obtained with the scanner 111 reading the original placed on the platen glass and stores the printing data received from the controller unit 101 via a network. The read only memory (ROM) 104 stores a boot program of a system. The HDD (hard disk drive) 105 stores the operating system, the system software, the application software, the printing data, setting data, and the like.

The operation unit I/F 106 is an interface unit for the operation unit 107 and outputs information to be displayed on the operation unit 107 to the operation unit 107. Additionally, the operation unit I/F 106 receives information inputted by the user from the operation unit 107.

The network I/F 108 is connected with the communication unit 109 and controls various communications established with the external device. The device I/F 110 connects the scanner 111 that executes reading of the original to the controller unit 101 and also connects the printer 112 that executes printing based on the image data to the controller unit 101 to input and output the image data.

The scanner 111 includes the platen glass to execute pre-scanning to detect a sheet size and a position of the original placed on the platen glass and execute scanning for the printing data obtainment in which the original placed on the platen glass is read to generate the image data.

### (Software Configuration of Image Formation Apparatus)

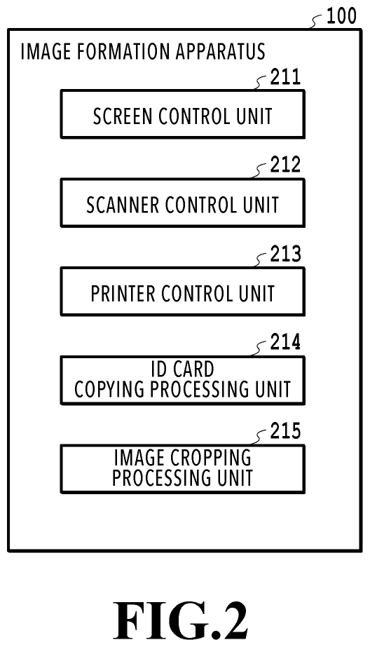

FIG. 2 is a block diagram illustrating a software configuration example of the image formation apparatus 100 according to the present embodiment. Each block in FIG. 2 is software stored in the ROM 104 or the HDD 105 and implements processing described later with the CPU 102 reading out the software to the RAM 103 to execute. The image formation apparatus 100 includes a screen control unit 211, a scanner control unit 212, a printer control unit 213, and an ID card copying processing unit 214.

The screen control unit 211 controls the operation unit 107 via the operation unit I/F 106. The screen control unit 211 receives the information inputted to the operation unit 107 by the user operation and generates a screen to be displayed on the operation unit 107. That is, it can be said that the screen control unit 211 display-controls a UI screen described later in detail.

The scanner control unit 212 controls the scanner 111 via the device I/F 110 and generates the image data by reading the original placed on the platen glass.

The printer control unit 213 controls the printer 112 via the device I/F 110 and prints and outputs the image based on the image data on the sheet.

The ID card copying processing unit 214 performs processing to implement an ID card copying function. The ID card copying processing unit 214 generates the printing data integrating front surface image data and back surface image data of the ID card on one surface of a single sheet based on setting of the ID card copying and checks the position of the ID card placed on the platen glass. That is, the ID card copying processing unit 214 generates a combined image, which is obtained by integrating two scanned images corresponding to two original surfaces obtained by scanning the front surface and the back surface of the ID card (a specific original) according to a set layout method, which is described later in detail. Additionally, the ID card copying processing unit 214 detects the position of the ID card (the specific original) by checking a range determined in advance on the platen glass.

The image cropping processing unit 215 performs cropping processing on the image data obtained by the reading with the scanner 111. In the present embodiment, processing in which only a cropped image as a necessary region is cut out from the image data while performing tilt correction and rotation concurrently to correct the image expressed by the image data to face the front is defined as the cropping processing. The image data cut out is not limited to a single card. Multiple card images may be extracted from the image data obtained by executing the reading with the scanner 111 once while multiple cards are placed on the platen glass. This processing is called multi-cropping processing.

### (Processing of Executing ID Card Copying Function)

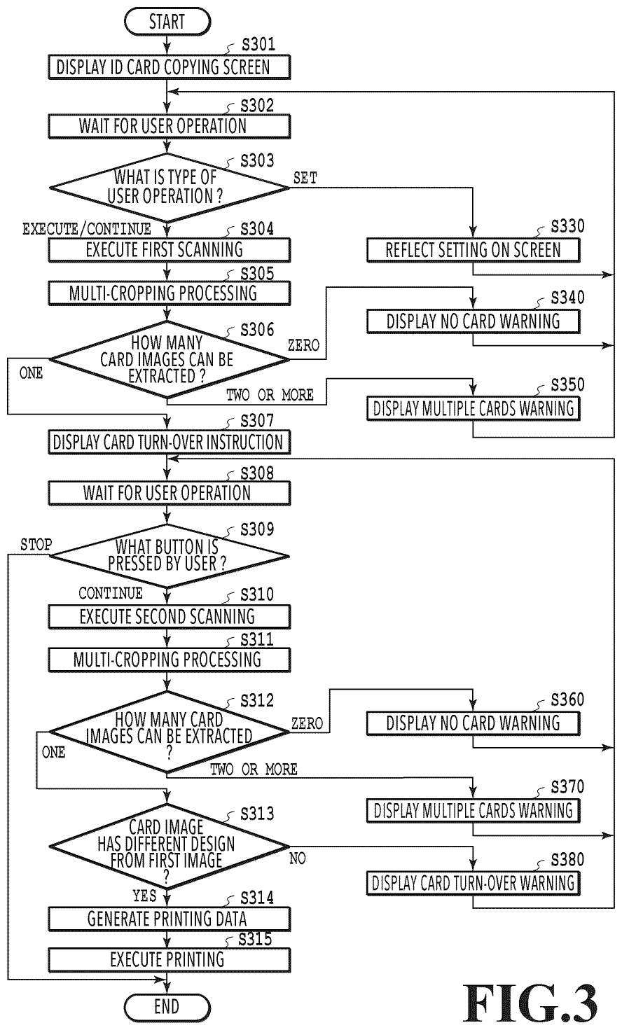

FIG. 3 is a flowchart describing processing of the ID card copying function executed by the image formation apparatus 100 according to the present embodiment. The flowchart in FIG. 3 is implemented with the CPU 102 of the image formation apparatus reading out the program to implement each software module stored in the ROM 104 or the HDD 105 to the RAM 103 to execute.

In the present embodiment, the ID card copying function is configured as an independent application; however, it is not limited thereto. The ID card copying function may be prepared as one function of a copying application. Note that, the ID card is placed in a predetermined position on the platen glass with the back surface of the ID card facing up.

In S301, in a case where the screen control unit 211 receives an instruction to execute the ID card copying function by the user operation on the operation unit 107, the screen control unit 211 activates an ID card copying application and displays an ID card copying screen on the operation unit 107.

### (ID Card Copying Screen)

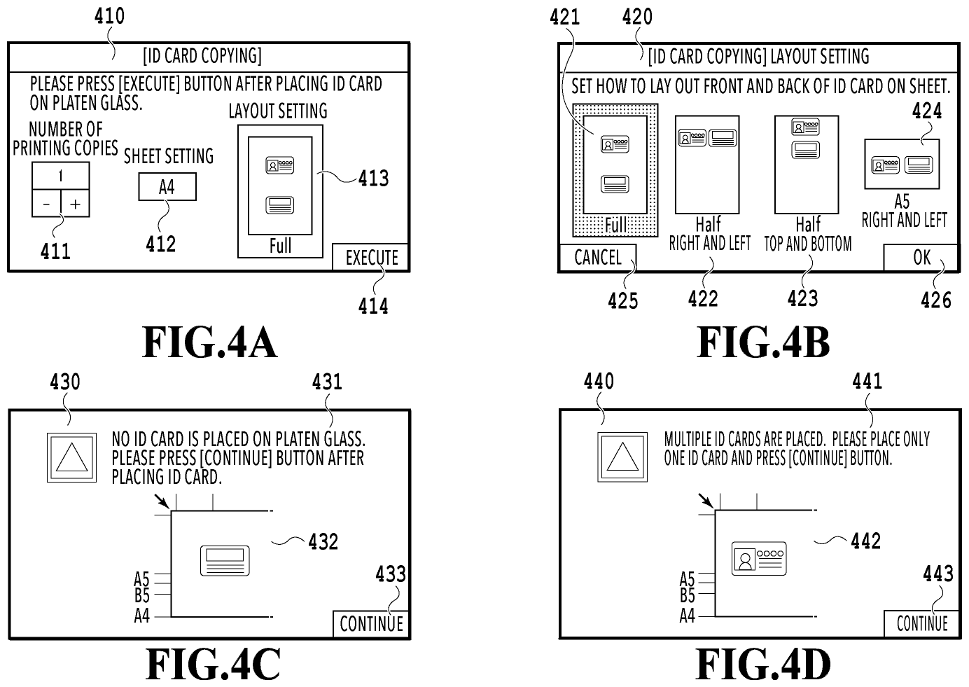

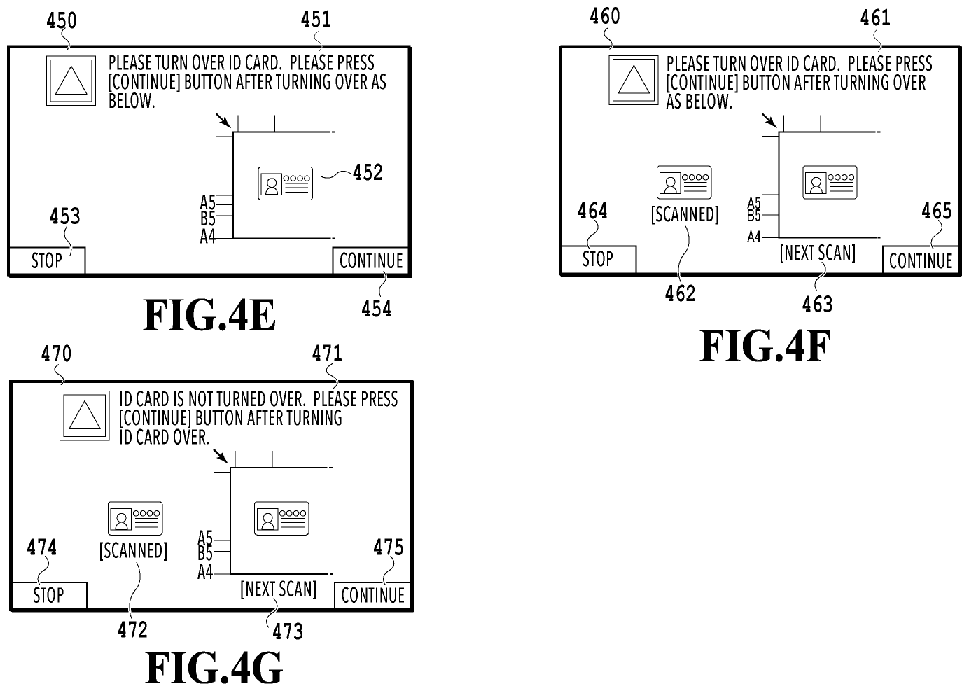

FIG. 4A is a diagram illustrating an ID card copying screen example. An ID card copying screen 410 includes copy number setting 411, sheet size setting 412, layout setting 413, and an “execute” button 414. The copy number setting 411 is a part to display setting of the number of printing copies and set the number of printing copies. The user changes the setting of the number of printing copies by using a “+” button to perform an operation to increment the number of printing copies and a “−” button to perform an operation to decrement the number of printing copies. The sheet size setting 412 is a part to display setting of the printing sheet size and set the printing sheet size. The sheet size setting 412 is a button and displays a screen (not illustrated) to select the printing sheet size by pressing. The layout setting 413 is a part to display setting of the layout method to how to lay out the image of the front surface and the image of the back surface of the ID card on the printing sheet and set the layout method. The layout setting 413 is a button and displays a screen (for example, a screen illustrated in FIG. 4B) to select the setting of the layout method by being pressed. The “execute” button 414 is a button to instruct starting the execution of the ID card copying function.

### (Layout Setting Screen)

FIG. 4B is a diagram illustrating a layout setting screen example. A layout setting screen 420 is displayed on the operation unit 107 by pressing the layout setting 413 on the ID card copying screen 410 illustrated in FIG. 4A by the user operation. In the present embodiment, there are four types of layout methods, which are “Full”, “Half right and left”, “Half top and bottom”, and “A5 right and left”, as the layout method that allows for the layout setting.

The layout setting screen 420 includes buttons 421 to 424 corresponding to the settable layout methods, respectively, a “cancel” button 425, and an “OK” button 426. The buttons 421 to 424 are buttons to change the layout method to be set, and the button pressed by the user operation is in a selected state. That is, it can be said that the layout setting screen 420 is a UI screen to set one of the multiple layout methods.

The button 421 is a button to set the layout method of “Full”. That is, the button 421 is a button to select setting in which the printing direction is the vertical direction, and the two scanned images corresponding to the front surface and the back surface of the ID card, respectively, are laid out next to each other in the vertical direction in an entire region on the one surface of the sheet.

The button 422 is a button to set the layout method of “Half right and left”. That is, the button 422 is a button to select setting in which the printing direction is the vertical direction, and the two scanned images corresponding to the front surface and the back surface of the ID card, respectively, are laid out next to each other in the horizontal direction in an upper half region on the one surface of the sheet.

The button 423 is a button to set the layout method of “Half top and bottom”. That is, the button 423 is a button to select setting in which the printing direction is the vertical direction, and the two scanned images corresponding to the front surface and the back surface of the ID card, respectively, are laid out next to each other in the vertical direction in the upper half region on the one surface of the sheet.

The button 424 is a button to set the layout method of “A5 right and left”. That is, the button 424 is a button to select setting in which the printing direction is the horizontal direction, and the two scanned images corresponding to the front surface and the back surface of the ID card, respectively, are laid out next to each other in the horizontal direction in the entire region on the one surface of the sheet of an A5 size.

The “cancel” button 425 is a button to return to the previous screen without changing the setting of the layout method. The “OK” button 426 is a button to return to the previous screen by determining the setting of the layout method currently selected from the buttons 421 to 424.

Back to the description of the flowchart in FIG. 3. In S302, the ID card copying processing unit 214 waits for the operation by the user via the screen control unit 211. That is, the ID card copying processing unit 214 waits for an input by the user operation on the ID card copying screen. In S303, the ID card copying processing unit 214 determines a type of the detected user operation. The processing diverges depending on the determination result. That is, if the type of the detected user operation is “set”, the processing proceeds to S330, and if the type of the detected user operation is “execute” or “continue”, the processing proceeds to S304.

The type of the user operation of “set” is an operation to perform setting for the ID card copying function such as, for example, increase and decrease of the number of copies in a region of the copy number setting 411 and the setting of the layout method on the layout setting screen 420. In S330, the ID card copying processing unit 214 reflects a setting value set by the user operation on the ID card copying screen 410. Then, once the reflecting of the setting value on the ID card copying screen 410 ends, the processing returns to S302.

The type of the user operation of “execute” or “continue” is an operation corresponding to pressing of the “execute” button 414 or pressing of a “continue” button 433 in FIG. 4C and a “continue” button 443 in FIG. 4D described later. In S304, the ID card copying processing unit 214 executes first scanning by controlling the scanner 111 via the scanner control unit 212 and generates (obtains) scanned image data.

In S305, the ID card copying processing unit 214 performs the multi-cropping processing on the scanned image data obtained in S304 via the image cropping processing unit 215 and extracts card image data. Specifically, the image cropping processing unit 215 extracts the card image data obtained by cutting out only a necessary region from the scanned image data obtained in S304 while performing tilt correction and rotation concurrently to correct the image expressed by the image data to face the front. The processing of rotation is processing in which character recognition processing is performed on the scanned image from four directions to determine a direction with the highest rate of the recognition as a character, and the vertical direction is set based on the direction obtained by the above determination, which is performed as needed.

In S306, the ID card copying processing unit 214 determines the number of the card image data extracted by the multi-cropping processing in S305. The processing diverges depending on the determination result. That is, if the number of the extracted card image data is zero, the processing proceeds to S340, if the number of the extracted card image data is one, the processing proceeds to S307, and if the number of the extracted card image data is two or more, the processing proceeds to S350.

In S340, the ID card copying processing unit 214 displays a no card warning screen on the operation unit 107 via the screen control unit 211.

### (No Card Warning Screen)

FIG. 4C is a diagram illustrating a no card warning screen example. A no card warning screen 430 includes a warning message 431, a guide display region 432, and the “continue” button 433. The no card warning screen 430 is also used in S360 (warning for second scanning) described later. The warning message 431 is a message indicating that no ID card is placed on the platen glass and indicating an operation procedure to continue the processing. The guide display region 432 is a region to visually display the placing of the ID card on the platen glass. A design of the ID card displayed in the guide display region 432 is also switched depending on whether it is a warning for the first scanning (S340) or a warning for the second scanning (S360). For example, in the first scanning, a design on the back surface side of the card is displayed because the front surface of the ID card is scanned. In the second scanning, a design on the front surface side of the card is displayed because the back surface of the ID card is scanned. The “continue” button 433 is a button to instruct the processing to continue. That is, it can be said that the no card warning screen 430 is a UI screen displayed in a case where a predetermined condition is not satisfied and is a UI screen to notify of a warning message.

Back to the description of the flowchart in FIG. 3. In S350, the ID card copying processing unit 214 displays a multiple cards warning screen indicating that multiple ID cards are placed on the platen glass on the operation unit 107 via the screen control unit 211.

### (Multiple Cards Warning Screens)

FIG. 4D is a diagram illustrating a multiple cards warning screen example. A multiple cards warning screen 440 includes a warning message 441, a guide display region 442, and the “continue” button 443. The multiple cards warning screen 440 is also used in S370 (a warning for the second scanning) described later. The warning message 441 is a message indicating that the multiple ID cards are placed on the platen glass and an operation procedure to continue the processing. The guide display region 442 is a region to visually display the placing of a single ID card on the platen glass. The design of the ID card displayed in the guide display region 442 is also switched depending on whether it is a warning for the first scanning (S350) or a warning for the second scanning (S370). For example, in the first scanning, the design on the back surface side of the card is displayed because the front surface of the ID card is scanned.

In the second scanning, the design on the front surface side of the card is displayed because the back surface of the ID card is scanned. The “continue” button 443 is a button to instruct the processing to continue. That is, it can be said that the multiple cards warning screen 440 is a UI screen displayed in a case where a predetermined condition is not satisfied and is a UI screen to notify of a warning message.

Back to the description of the flowchart in FIG. 3. In S307, the ID card copying processing unit 214 displays a card turn-over instruction screen indicating an instruction to turn over the ID card placed on the platen glass on the operation unit 107 via the screen control unit 211.

### (Card Turn-Over Instruction Screen)

FIG. 4E is a diagram illustrating a card turn-over instruction screen example. A card turn-over instruction screen 450 includes a message 451, a guide display region 452, a “stop” button 453, and a “continue” button 454. The message 451 is a message indicating that the ID card placed on the platen glass needs to be turned over and an operation procedure to continue the processing. The guide display region 452 is a region to visually display the placing of a single ID card on the platen glass. The “stop” button 453 is a button to instruct the processing to stop. The “continue” button 454 is a button to instruct the processing to continue.

Additionally, the scanned card image may be displayed on the card turn-over instruction screen.

### (Card Turn-Over Instruction Screen)

FIG. 4F is a diagram illustrating a card turn-over instruction screen example that displays also the scanned card image. A card turn-over instruction screen 460 includes a message 461, a scanned card image 462, a guide display region 463, a “stop” button 464, and a “continue” button 465.

The message 461 is a message indicating that the ID card needs to be turned over and an operation procedure to continue the processing. The scanned card image 462 is an image extracted by performing the first scanning in S304 and performing the multi-cropping processing in S305. The guide display region 463 is a region to visually display the placing of a single ID card on the platen glass. The image of the ID card displayed in the guide display region 463 is the same image as the scanned card image 462. A state in which the ID card is turned over is visually displayed by displaying the same image as the scanned card image 462. The “stop” button 464 is a button to instruct the processing to stop. The “continue” button 465 is a button to instruct the processing to continue.

Back to the description of the flowchart in FIG. 3. After the processing in S307, the ID card placed on the platen glass is turned over by the user operation, and the ID card is placed in a predetermined position on the platen glass with the front surface of the ID card facing up.

In S308, the ID card copying processing unit 214 waits for an operation by the user via the screen control unit 211. That is, the ID card copying processing unit 214 waits for an input by the user operation on the card turn-over instruction screen 450 or the card turn-over instruction screen 460.

In S309, the ID card copying processing unit 214 determines the type of the button pressed by the user. The processing diverges depending on the determination result. That is, if the detected button pressed by the user is the “stop” button, the flowchart illustrated in FIG. 3 ends, and if the detected button pressed by the user is the “continue” button, the processing proceeds to S310.

In S310, the ID card copying processing unit 214 executes the second scanning by controlling the scanner 111 via the scanner control unit 212 and generates the image data. That is, the ID card copying processing unit 214 obtains a single scanned image corresponding to the back surface of the ID card (a single original surface) obtained by scanning the back surface of the ID card.

In S311, the ID card copying processing unit 214 performs the multi-cropping processing on the scanned image data obtained in S310 via the image cropping processing unit 215 and extracts the card image data. Specifically, the image cropping processing unit 215 extracts the card image data obtained by cutting out only a necessary region from the scanned image data obtained in S310 while performing tilt correction and rotation concurrently to correct the image expressed by the image data to face the front.

In S312, the ID card copying processing unit 214 determines the number of the card image data extracted by the multi-cropping processing in S311. The processing diverges depending on the determination result. That is, if the number of the extracted card image data is zero, the processing proceeds to S360, if the number of the extracted card image data is one, the processing proceeds to S313, and if the number of the extracted card image data is two or more, the processing proceeds to S370.

In S360, as with S340, the ID card copying processing unit 214 displays the no card warning screen indicating that no ID card is placed on the platen glass on the operation unit 107 via the screen control unit 211. Note that, once the processing in S360 ends, the processing returns to S308.

In S370, as with S350, the ID card copying processing unit 214 displays the multiple cards warning screen indicating that the multiple ID cards are placed on the platen glass on the operation unit 107 via the screen control unit 211.

In S313, the ID card copying processing unit 214 determines whether the designs are different between the card image (the image extracted in S305) obtained in the first scanning and the card image (the image extracted in S311) obtained in the second scanning. If the determination result indicating that the first card image and the second card image have different designs is obtained, the processing proceeds to S314, and if the determination result indicating that the first card image and the second card image have the same design is obtained, the processing proceeds to S380. The result in which the first and the second card images have the same design means that the card is not turned over. Therefore, in S380, the ID card copying processing unit 214 displays a card turn-over warning screen indicating that the ID card placed on the platen glass is not turned over on the operation unit 107 via the screen control unit 211.

### (Card Turn-Over Warning Screen)

FIG. 4G is a diagram illustrating a card turn-over warning screen example. A card turn-over warning screen 470 includes a warning message 471, a scanned card image 472, a guide display region 473, a “stop” button 474, and a “continue” button 475. The warning message 471 is a message indicating that the ID card is not turned over and an operation procedure to continue the processing. The scanned card image 472 is an image extracted by performing the second scanning in S310 and performing the multi-cropping processing in S311. The guide display region 473 is a region to visually display the placing of a single ID card on the platen glass. The image of the ID card displayed in the guide display region 473 is the same image as the scanned card image 472. A state in which the ID card is turned over is visually displayed by displaying the same image as the scanned card image 472. The “stop” button 474 is a button to instruct the processing to stop. The “continue” button 475 is a button to instruct the processing to continue. That is, it can be said that the card turn-over warning screen 470 is a UI screen displayed in a case where a predetermined condition is not satisfied and is a UI screen to notify of a warning message.

Back to the description of the flowchart in FIG. 3. In S314, the ID card copying processing unit 214 generates the printing data based on the card image (the image extracted in S305) obtained in the first scanning and the card image (the image extracted in S311) obtained in the second scanning. In this process, positions where the two card images are to be laid out on the sheet are determined according to the setting of the layout method. That is, the ID card copying processing unit 214 generates the combined image, which is obtained by integrating the two scanned images corresponding to the two original surfaces obtained by scanning the front surface and the back surface of the specific original, according to the set layout method. In S315, the ID card copying processing unit 214 controls the printer 112 via the printer control unit 213 and prints the image based on the printing data generated in S314 on the sheet.

The flowchart illustrated in FIG. 3 ends with the above-described processing. In the present embodiment, a case where the combined image, which is obtained by integrating the two image data corresponding to the front surface and the back surface of the single ID card, is printed on one surface of the single sheet is described; however, it is not limited thereto. For example, the present embodiment may be applied to a case where the combined image, which is obtained by integrating two image data in total that are corresponding to one surface of each of two ID cards, is printed on one surface of the single sheet.

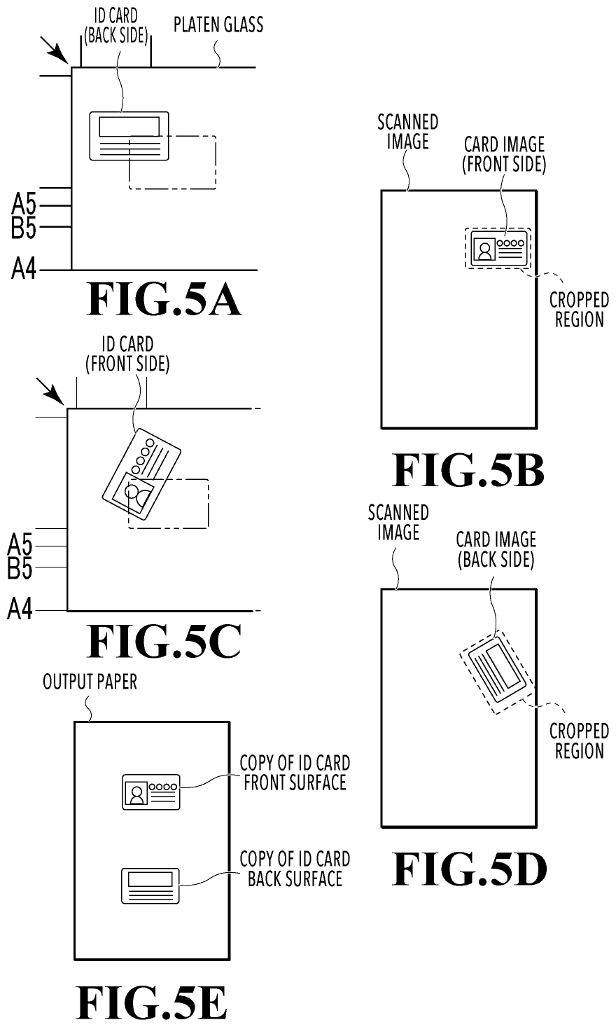

Here, a specific example of a case where the present embodiment is applied is described with reference to the drawings. FIG. 5A to FIG. 5E are each a diagram describing processing of the ID card copying function. FIG. 5A illustrates a placed position of the ID card in the first scanning, and FIG. 5B illustrates the scanned image obtained in the first scanning. Additionally, FIG. 5C illustrates a placed position of the ID card in the second scanning, and FIG. 5D illustrates the scanned image obtained in the second scanning. FIG. 5E illustrates output paper.

As illustrated in FIGS. 5A and 5B, even in a case where the ID card is placed in a position different from a predetermined position (a rectangle illustrated by a dashed-two dotted line) on the platen glass in the first scanning, it is possible to obtain the scanned image including the card image corresponding to the front surface of the ID card. Therefore, it is possible to extract a region corresponding to the ID card image (the front surface) as a cropped region by performing the multi-cropping processing on the first scanned image.

Additionally, as illustrated in FIGS. 5C and 5D, even in a case where the ID card is placed in a position different from a predetermined position (a rectangle illustrated by a dashed-two dotted line) on the platen glass in the second scanning, it is possible to obtain the scanned image including the card image corresponding to the back surface of the ID card. Therefore, it is possible to extract a region corresponding to the ID card image (the back surface) as a cropped region by performing the multi-cropping processing on the second scanned image.

Thus, it is possible to output the sheet on which the image based on the combined image, which is obtained by integrating the first card image illustrated in FIG. 5B and the second card image illustrated in FIG. 5D, is printed.

As described above, according to the present embodiment, it is possible to perform the ID card copying without limiting the position of the ID card placed on the platen glass, and the usability is improved. That is, it is possible to improve the usability in a case where the combined image, which is obtained by integrating the two scanned images of the specific original, is generated.

### Embodiment 2

In the present embodiment, an aspect in which the printing data in which identified two card images are arrayed is generated according to the setting of the layout method is described. The present embodiment is a modification of the embodiment 1; for this reason, a difference from the embodiment 1 is mainly described.

### (Layout Setting Screen)

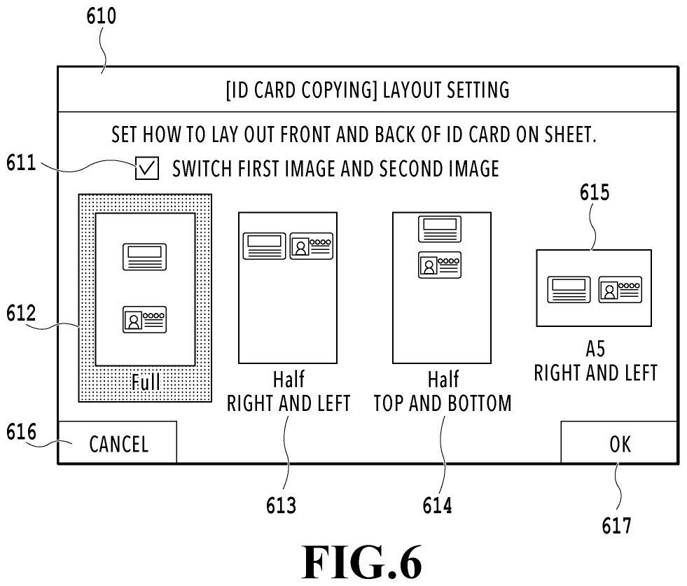

FIG. 6 is a diagram illustrating a layout setting screen example in which setting to invert the order of laying out the card images is added. A layout setting screen 610 is a screen in which a checkbox to invert the layout order of the card images is added to the layout setting screen 420 illustrated in FIG. 4B. The layout setting screen 610 includes a checkbox 611, buttons 612 to 615 corresponding to values of the settings of the layout methods, respectively, a “cancel” button 616, and an “OK” button 617.

The checkbox 611 is a checkbox to determine the order of laying out the card images, and the order of laying out the card images is inverted by checking or unchecking the checkbox. In conjunction with the checking or unchecking of the checkbox 611, the order of the card images illustrated in the buttons 612 to 615 are also switched. In FIG. 6, the checkbox 611 is checked; for this reason, the order of the card images illustrated in the buttons 612 to 615 is the opposite order of the card image (the front surface) and the card image (the back surface) in the buttons 421 to 424 illustrated in FIG. 4B. That is, in the vertical direction, the card image (the back surface) is displayed on an upper side, and the card image (the front surface) is displayed on a lower side. In the horizontal direction, the card image (the back surface) is displayed on a left side, and the card image (the front surface) is displayed on a right side. The “cancel” button 616 is a button to return to the previous screen by instructing the setting of the layout method to be canceled. The “OK” button 617 is a button to return to the previous screen by determining the setting of the layout method. That is, it can be said that the layout setting screen 610 is a UI screen to set one of the multiple layout methods and is a UI screen to display the setting to invert the layout order of the two cropped images such that the setting is selectable.

### (Processing of Executing ID Card Copying Function)

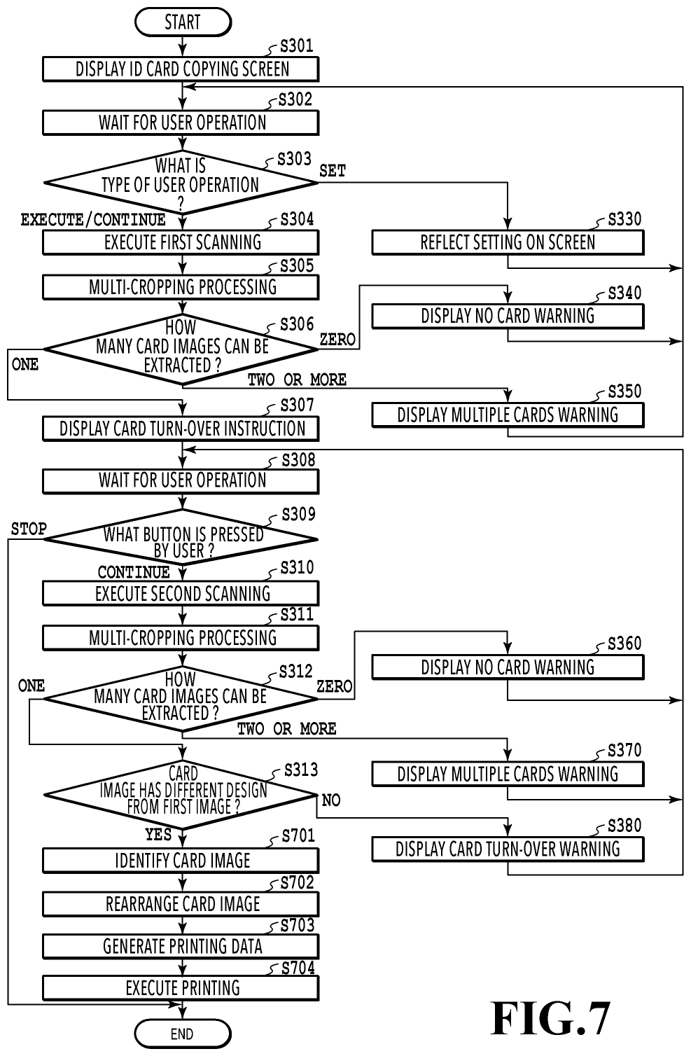

FIG. 7 is a flowchart describing processing of the ID card copying function executed by the image formation apparatus 100 according to the present embodiment. FIG. 7 is a flowchart that is a modification of the flowchart illustrated in FIG. 3. A difference from FIG. 3 is mainly described.

The flowchart in FIG. 7 is implemented with the CPU 102 of the image formation apparatus reading out the program to implement each software module stored in the ROM 104 or the HDD 105 to the RAM 103 to execute. In S313, if it is determined that the card image obtained in the first scanning and the card image obtained in the second scanning have different designs (YES in S313), the processing proceeds to S701.

In S701, the ID card copying processing unit 214 identifies the designs of the first card image (the image extracted in S305) and the second card image (the image extracted in S311).

As the method of identifying the design, for example, image recognition processing may be performed on the card image to identify the front surface and the back surface of the card image based on whether there is a face photograph obtained as the image recognition result. Additionally, character recognition processing may be performed on the card image to identify the front surface and the back surface of the card image based on a character size of a character obtained as the character recognition result. Moreover, in the card image, the similarity with the card image (the front surface) or the card image (the back surface) displayed in the buttons 612 to 615 on the layout setting screen may be obtained to identify the front surface and the back surface of the card image based on the obtained similarity.

In S702, the ID card copying processing unit 214 rearranges the card images in the same order as that of the setting of the layout method.

In S703, the ID card copying processing unit 214 generates the printing data based on the card image (the image extracted in S305) obtained in the first scanning and the card image (the image extracted in S311) obtained in the second scanning. In this process, the positions where the two card images are to be laid out on the sheet are determined according to the setting of the layout method. That is, the ID card copying processing unit 214 generates the combined image, which is obtained by integrating the two scanned images corresponding to the two original surfaces obtained by scanning the front surface and the back surface of the specific original, according to the set layout method. In S704, the ID card copying processing unit 214 controls the printer 112 via the printer control unit 213 and prints the image based on the printing data generated in S703 on the sheet. With the above processing, the flowchart illustrated in FIG. 7 ends.

As described above, according to the present embodiment, it is possible to print the combined image, which is obtained by integrating the two card images in the order indicated by the set layout method, on the sheet. Since there is no need to perform an operation to rearrange the two card images, the user operation is simple, and it is possible to improve the usability in a case where the ID card copying function is executed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technique of the present disclosure, it is possible to improve the usability in a case where a combined image, which is obtained by integrating two scanned images of a specific original, is generated.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-193499, filed Nov. 14, 2023, which is hereby incorporated by reference wherein in its entirety.

What is claimed is:

1. An image formation apparatus, comprising:
an obtainment unit configured to obtain two cropped images by performing cropping processing on two scanned images corresponding to two original surfaces that are obtained by scanning a specific original; and
a generation unit configured to generate a combined image, which is obtained by integrating the two cropped images obtained by the obtainment unit.

2. The image formation apparatus according to claim 1, further comprising:
a notification unit configured to notify of a warning message in a case where the scanned image or the cropped image does not satisfy a predetermined condition.

3. The image formation apparatus according to claim 2, wherein
in a case where no cropped image is obtained from the single scanned image by the obtainment unit, the notification unit notifies of the warning message indicating that no specific original is placed on a platen glass.

4. The image formation apparatus according to claim 2, wherein
in a case where two or more cropped images are obtained from the single scanned image by the obtainment unit, the notification unit notifies of the warning message indicating that two or more specific originals are placed on a platen glass.

5. The image formation apparatus according to claim 2, wherein
in a case where a design of one of the two cropped images is the same design as that of the other one of the two cropped images, the notification unit notifies of the warning message indicating that the specific original placed on a platen glass is not turned over.

6. The image formation apparatus according to claim 1, wherein
the generation unit identifies the two cropped images and generates the combined image, which is obtained by integrating and arraying the identified two cropped images according to a layout method applied in a case where the combined image, which is obtained by integrating the two cropped images, is generated.

7. The image formation apparatus according to claim 1, further comprising:
a setting unit configured to set a layout method applied in a case where the combined image, which is obtained by integrating the two cropped images, is generated, wherein
the generation unit generates the combined image, which is obtained by integrating the two cropped images, based on the layout method set by the setting unit.

8. The image formation apparatus according to claim 7, further comprising:
a display control unit while there are a plurality of the layout methods, the display control unit being configured to display a UI screen to set one layout method out of the plurality of the layout methods, wherein
the setting unit sets setting of the one layout method based on a user operation via the UI screen displayed by the display control unit.

9. The image formation apparatus according to claim 8, wherein
the UI screen displays setting to invert a layout order of the two cropped images such that the setting is selectable.

10. The image formation apparatus according to claim 1, wherein
the generation unit generates the combined image, which is obtained by integrating the two cropped images obtained from the two scanned images corresponding to a front surface and a back surface of the specific original.

11. The image formation apparatus according to claim 1, wherein
the generation unit generates the combined image, which is obtained by integrating the two cropped images obtained from the two scanned images corresponding to a front surface of each of two specific originals.

12. The image formation apparatus according to claim 1, wherein
the specific original is an ID card.

13. An image formation method, comprising:
obtaining two cropped images by performing cropping processing on two scanned images corresponding to two original surfaces that are obtained by scanning a specific original; and
generating a combined image, which is obtained by integrating the two cropped images obtained by the obtaining.

14. A non-transitory computer readable storage medium storing a program which causes a computer to perform an image formation method, comprising:
obtaining two cropped images by performing cropping processing on two scanned images corresponding to two original surfaces that are obtained by scanning a specific original; and
generating a combined image, which is obtained by integrating the two cropped images obtained by the obtaining.
